(19) United States
(12) Patent Application Publication
(10) Pub. No.: US 2020/0310777 A1
(43) Pub. Date: Oct. 1, 2020

(54) EFFICIENT BINARY RESOURCE DISTRIBUTION TO CLIENT COMPUTING DEVICES

(71) Applicant: ELECTRONIC ARTS INC., Redwood City, CA (US)

(72) Inventors: Hendrikus Lambertus Johannes van Veenendaal, Vancouver (CA); Thomas Henri van Dijck, Alvsjo (SE)

(21) Appl. No.: 16/364,638

(22) Filed: Mar. 26, 2019

(51) Int. Cl. G06F 8/65; H04L 29/08

(52) U.S. Cl. CPC G06F 8/65; H04L 67/34

(57) ABSTRACT

An example method of efficient binary resource distribution to client computing devices connected to content delivery networks (CDNs) comprises: receiving, by a client computing device, build metadata associated with a new build of a software product, wherein the new build comprises a plurality of binary resources; identifying, based on the build metadata, a subset of reusable locally stored binary resources comprised by a current build of the software product, wherein each binary resource of the subset matches a corresponding binary resource of the new build; and responsive to identifying a binary resource of the new build, such that the binary resource that does not have a corresponding reusable locally stored binary resource of the current build, downloading at least a part of the binary resource from a CDN.

### TECHNICAL FIELD

The present disclosure is generally related to CDNs, and is more specifically related to methods and system for efficient binary resource distribution to client computing devices.

### BACKGROUND

Software products may be distributed, in the form of one or more files, to multiple client computing devices via a content delivery network (CDN). Each of the files may store one or more binary resources, such as executable code files, data files, graphic assets (e.g., textures, still images, fonts, animated images, video streams), multimedia assets, sound streams, etc. Examples of software products include interactive videogames, e-commerce applications, and various other business and/or entertainment applications.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates a high-level diagram of an example CDN operating in accordance with one or more aspects of the present disclosure;

FIG. 2 schematically illustrates an example resource-aware resource patching technique which utilizes information about the resource size and offset within the current and new builds, in accordance with one or more aspects of the present disclosure;

FIG. 3 depicts an example method of creating a patch plan for efficient binary resource distribution to client computing devices, in accordance with one or more aspects of the present disclosure;

FIG. 4 schematically illustrates a memory data structure which may be involved for storing the resource metadata utilized by the patching process implemented in accordance with one or more aspects of the present disclosure;

FIG. 5 depicts a flowchart of an example method 500 of efficient binary resource distribution to client computing devices, in accordance with one or more aspects of the present disclosure; and

FIG. 6 schematically illustrates a diagrammatic representation of an example computing device which may implement the systems and methods described herein.

### DETAILED DESCRIPTION

Described herein are methods and systems for efficient binary resource distribution to client computing devices connected to content delivery networks (CDNs).

Software products may be distributed, in the form of one or more files, to multiple client computing devices via a CDN. Each of the files may store one or more binary resources, such as executable code files, data files, graphic assets (e.g., textures, still images, fonts, animated images, video streams), multimedia assets, sound streams, etc. Examples of software products include interactive videogames, e-commerce applications, and various other business and/or entertainment applications.

Since a software product lifecycle may include multiple versions, such that upgrading from the current build level (or “version”) to a subsequent build level involves updating the binary resources stored by the CDN, each client computing device may perform corresponding updates of the locally stored binary files forming the current build of the software product, thus upgrading the locally installed software product build to the new version available from the CDN.

Since a typical product update modifies a subset of the installed binary resources and/or introduces new binary resources, while re-using at least some portion of the installed binary resources, such incremental updates involve file “patching,” e.g., partially overwriting locally stored files with the content downloaded from the CDN in form of fixed or variable size blocks. Various patching techniques attempt to identify re-usable portions of the locally installed product build that may be utilized by the upgraded build. In certain implementations, the patching process involves identifying matching blocks of a predetermined size in the existing build and the new build, thus only downloading new or modified blocks. However, the fixed block size may hinder the overall process efficiency since the whole block should be downloaded event if only one byte of the block was modified in the new build as compared to the current build. Furthermore, the matching blocks are identified by block-by-block comparison (e.g., by comparing the hashes of the corresponding blocks in the current build and the new build) starting from the beginning of the file set and incrementing the offset of the current block by the fixed block size. Such a process would not be capable of re-using an existing block which was moved or duplicated within the build so that the offset of the block in the new build has become different from the offset of the same block within the current build.

The systems and methods of the present disclosure alleviate this and other deficiencies of various fixed block size patching techniques by implementing resource-aware patching techniques which utilize information about the resource sizes and offsets within the current and new builds. The resource information may be provided to the client computing device in the form of the build metadata for the current and new builds. The build metadata may for each resource, specify the file in which the resource is stored, the resource offset within the file, the resource size, and the resource hash.

Accordingly, the patching method may involve comparing the current build metadata and the new build metadata in order to identify, in the locally stored current build, a subset of resources which may be reused in the new build without any modifications. For the remaining resources of the new build (i.e., resources of the new build for which corresponding resources of the current build do not exist or cannot be reused without at least some modifications), block scanning may be performed in order to identify any locally stored blocks which may be reused for the new or modified resources. The remaining blocks of the new build (i.e., blocks of the new build for which corresponding blocks of the current build do not exist) may then be downloaded from the CDN. If necessary, the updated and/or newly downloaded resources may be copied locally to create any requisite duplicate instances of the resources in the new build.

This patching process would minimize the amount of data to be downloaded from the CDN as compared to fixed block scanning methods, but also it would be capable of re-using an existing block which was moved or duplicated within the file or across the file boundaries within the build. Thus, the resource-aware patching techniques implemented by client computing devices and/or CDNs in accordance with one or more aspects by the present disclosure effectively minimize the total size of content to be downloaded from the CDNs, thus reducing both the time and the necessary to update the product built installed on a client computing device and the bandwidth usage by the update, as described in more detail herein below.

Various aspects of the methods and systems for efficient binary resource distribution to client computing devices are described herein by way of examples, rather than by way of limitation. The methods described herein may be implemented by hardware (e.g., general purpose and/or specialized processing devices, and/or other devices and associated circuitry), software (e.g., instructions executable by a processing device), or a combination thereof.

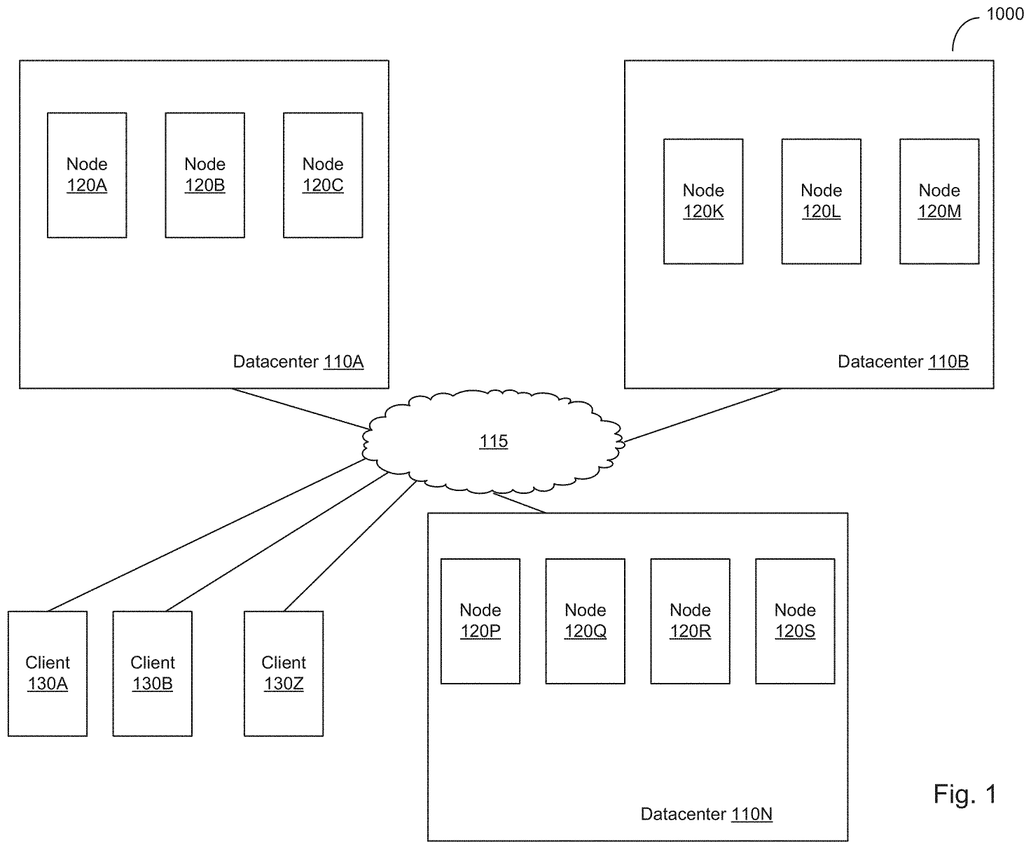

FIG. 1 schematically illustrates a high-level diagram of an example CDN operating in accordance with one or more aspects of the present disclosure. Computing devices, appliances, and network segments are shown in FIG. 1 for illustrative purposes only and do not in any way limit the scope of the present disclosure. Various other computing devices, components, and appliances not shown in FIG. 1, and/or methods of their interconnection may be compatible with the methods and systems described herein. Various functional or auxiliary network components (e.g., firewalls, load balancers, network switches, user directories, content repositories, etc.) may be omitted from FIG. 1 for clarity.

In the illustrative example of FIG. 1, the CDN 1000 may include content delivery nodes 120A-120K residing in multiple datacenters 110A-110N interconnected by one or more networks 115, such that each datacenter 110 hosts a plurality of content delivery node nodes 120. In the illustrative example of FIG. 1, each cluster of delivery nodes 120 located in a datacenter 110 collectively stores the full set of distribution files forming the current build of a software product to be distributed to the client computing devices 130A-130Z.

The datacenters 110A-110N may be geographically distributed in order to increase the overall throughput and reduce the network-related latency in servicing the client requests, e.g., by redirecting each request to a datacenter which is located in a geographic proximity to the request-originating client. The CDN 1000 may implement various load balancing mechanisms, cache coherence protocols and strategies, and/or other techniques aimed at improving the efficiency of the content distribution.

Distribution of binary resources to client computing devices 130A-130Z may involve receiving, by each client computing device, build metadata utilized for creating a patch plan, creating a directory structure for the new build, creating empty files (e.g., with a predetermined filename extension, such as .patch) in the directory structure, and executing the patch plan that specifies a sequence of operations to be performed by the client computing device in order to upgrade a locally installed software product from the current build to the new build level matching the latest build level available from the CDN. In certain implementations, executing the patch plan may involve moving resources from the current build into the new build locations within the created directory structure, downloading the missing resource data, copying at least some of the resources into secondary locations thus creating multiple instances of such resources in the new build, and renaming the patched files, and described in more details herein below.

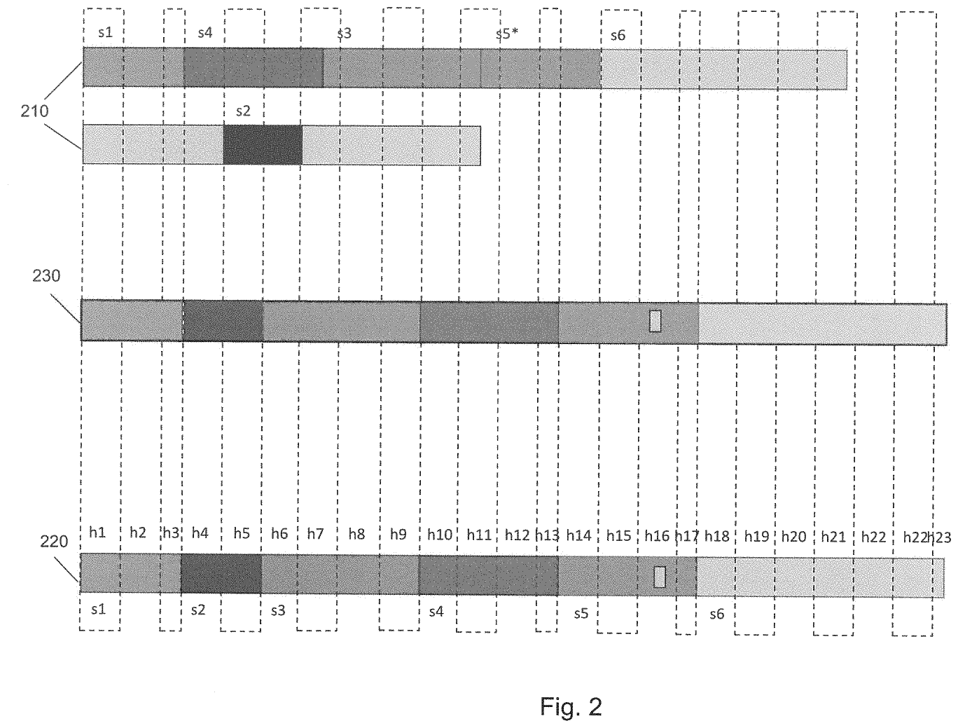

FIG. 2 schematically illustrates an example resource-aware resource patching technique which utilizes information about the resource size and offset within the current and new builds, in accordance with one or more aspects of the present disclosure. As schematically illustrated by FIG. 2, the current build 210 is locally stored on a client computing device, the set of files 220 of the new build is stored on the CDN, and the patching process produces the new build 230 locally stored on the client computing device.

The resource information may be provided to the client computing device in the form of the build metadata, which may, for each resource, specify the file in which the resource is stored, the resource offset within the file, the resource size, and the resource hash. The hash may be represented by an irreversible function mapping a first byte sequence of arbitrary size to a second byte sequence of a pre-determined size, such that two different input byte sequences are unlikely to produce the same hash value. In an illustrative example, MD5 hash function may be utilized for computing hashes of the binary resources. In an illustrative example, SHA-1 hash function may be utilized. Alternatively, other hashing algorithms may be employed.

In certain implementations, the build metadata may be derived from various metadata provided by the software development framework that was employed for producing the software product build. Alternatively, the build metadata may be produced by inspecting the software product build in order to identify resources and their offsets within the build and computing the resource hashes.

Accordingly, the patching method may involve identifying, based on comparing the build metadata for the CDN-resident new build and the locally stored current build, a subset of the locally stored current build resources which may be reused in the new build without any modifications. Identifying these reusable resources may involve iterating through the resources of the new build and, for each resource of the new build, comparing its hash with resource hashes of resources of the current build; should a current build resource having a hash that matches the hash of the new build resource be identified, the identified current build resource may be reused in the new build without any modifications. Accordingly, the identified current build resource may be copied from the current build file and the offset within the current build file specified by the current build metadata to the new build file and the offset within the new build file specified by new build metadata.

In the illustrative example of FIG. 2, resources S1, S2, S4, and S6 of the locally stored current build 210 match the respective resources S1, S2, S4, and S6 of the set of files 220 of the new build that is stored on the CDN, and thus these resources may be locally copied by the client computing device from the current build 210 to the new build 230. Notably, the differences between the order and offsets of the resources in the current build 210 and the order and offsets of the resources in the CDN-resident new build 220 do not impede identification of the matching resources, which is performed based on the resource hash values provided by the build metadata.

The remaining resources of the new build (i.e., resources of the new build for which corresponding resources of the current build do not exist or cannot be reused without at least some modifications due to the hash mismatch, e.g., as resource S5) may be at least partially downloaded from the CDN. In certain implementations, each of these resources may be fully downloaded from the CDN. Alternatively, block scanning may be performed in order to identify any locally stored blocks which can be reused for the new or modified resources.

Identifying these reusable blocks may involve iterating through the blocks of the new build resource and, for each block of the new build resource, comparing its hash with block hashes of the current build; should a current build block having a hash that matches the hash of the new build block be identified, the identified block of the current build may be reused in the new build. Accordingly, the identified block of the current build may be copied from the current build file and the offset within the current build file specified by the current build metadata to the new build file and the offset within the new build file specified by new build metadata.

The remaining blocks of the new build (i.e., blocks of the new build for which corresponding blocks of the current build do not exist) may then be downloaded from the CDN. Accordingly, each remaining block of the new build may be downloaded from the CDN (based on the new build file and the offset within the new build file specified by the new build metadata) and saved locally to the new build file and the offset within the new build file specified by new build metadata.

In the illustrative example of FIG. 2, resource S5 of the CDN-resident new build 220 includes for blocks having the hash values of h14, h15, h16, and h17. The blocks having the hash values of h14, h15, and h17 are also present in the locally stored current build 210 and thus may be reused in the new build 230. Conversely, the block having the hash value h15 is absent from the current build 220 and thus will need to be downloaded by the client computing device from the CDN in order to be included into the new build 230, thus completing the resource S5.

Furthermore, since some of the resources may be duplicated (e.g., stored in two or more files of the new build), the downloaded and/or modified resources may be copied locally to create any requisite duplicate instances of the resources in the new build.

As noted herein above, the patching process may be performed in accordance with a patch plan that specifies a sequence of operations to be performed by the client computing device in order to upgrade a locally installed software product from the current build level to the new build level matching the latest build level available from the CDN. The patch plan may be created based on comparing the current build metadata (for the locally stored current build) and the new build metadata (for the CDN-resident new build). The build metadata may specify, for each resource, the file in which the resource is stored, the resource offset within the file, the resource size, and the resource hash.

In certain implementations, the patch plan may be created by each client computing device. Alternatively, the patch plan may be created by the CDN and downloaded by each client computing device.

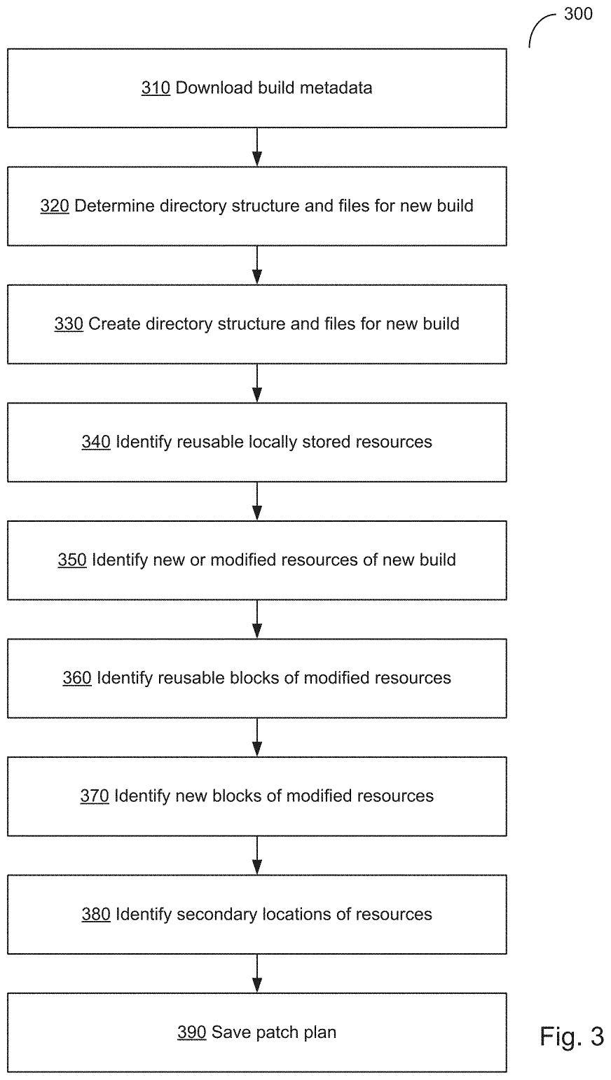

FIG. 3 depicts an example method of creating a patch plan for efficient binary resource distribution to client computing devices, in accordance with one or more aspects of the present disclosure. Method 300 and/or each of its individual functions, routines, subroutines, or operations may be performed by one or more processors of a client computing device (e.g., a client computing device 130 of FIG. 1). In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other. Therefore, while FIG. 3 and the associated description lists the operations of method 300 in certain order, various implementations of the method may perform at least some of the described operations in parallel and/or in arbitrary selected orders.

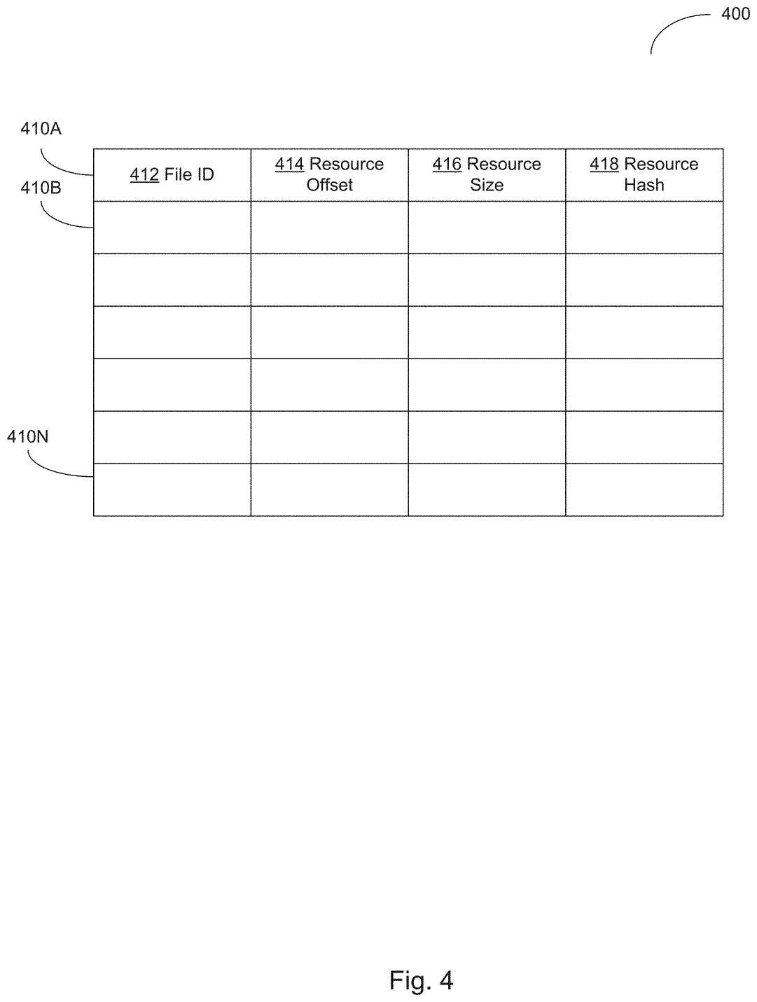

As schematically illustrated by FIG. 3, at block 310, the client computing device may download the new build metadata from the CDN. The new build metadata may, for each resource, specify the file in which the resource is stored, the resource offset within the file, the resource size, and the resource hash, as described in more detail herein above with reference to FIG. 4. The current build metadata (e.g., the metadata associated with the locally stored current build) is presumed to be available and locally stored by the client computing device, e.g., since it was previously downloaded at the time of initial installation or the previous upgrade of the software product.

At block 320, the client computing device may determine, by comparing the current build metadata and the new build metadata, the directory structure and generate a list of the files that need to be created or patched in the new build.

At block 330, the client computing device may create the directory structure for the new build and create the empty files (e.g., with a predetermined filename extension, such as .patch) in the directory structure.

At block 340, the client computing device may identify locally stored existing resources (i.e., resources of the current build) that may be reused for the new build.

At block 350, the client computing device may identify the remaining resources of the new build (i.e., resources of the new build for which corresponding resources of the current build do not exist or cannot be reused).

At block 360, the client computing device may identify the locally stored blocks which can be reused for the new or modified resources.

At block 370, the client computing device may identify the remaining blocks of the new build (i.e., blocks of the new build for which corresponding blocks of the current build do not exist) that need be downloaded from the CDN.

At block 380, the client computing device may identify the secondary locations for copying the resources in order to create any requisite duplicate instances of the resources in the new build.

At block 390, the client computing device may save the created patch plan, and the method may terminate.

FIG. 4 schematically illustrates a memory data structure which may be involved for storing the resource metadata utilized by the patching process implemented in accordance with one or more aspects of the present disclosure. As schematically illustrated by FIG. 4, the data structure 400 may include multiple records 410A-410N, such that each records represents a binary resource. Each record 410 may include the identifier 412 of the file in which the resource is stored, the resource offset 414, resource size 416, and resource hash 418. The data structure 400 may be utilized for storing both the current build metadata and the new build metadata which are utilized by the client computing device for creating the patch plan, as described in more detail herein above.

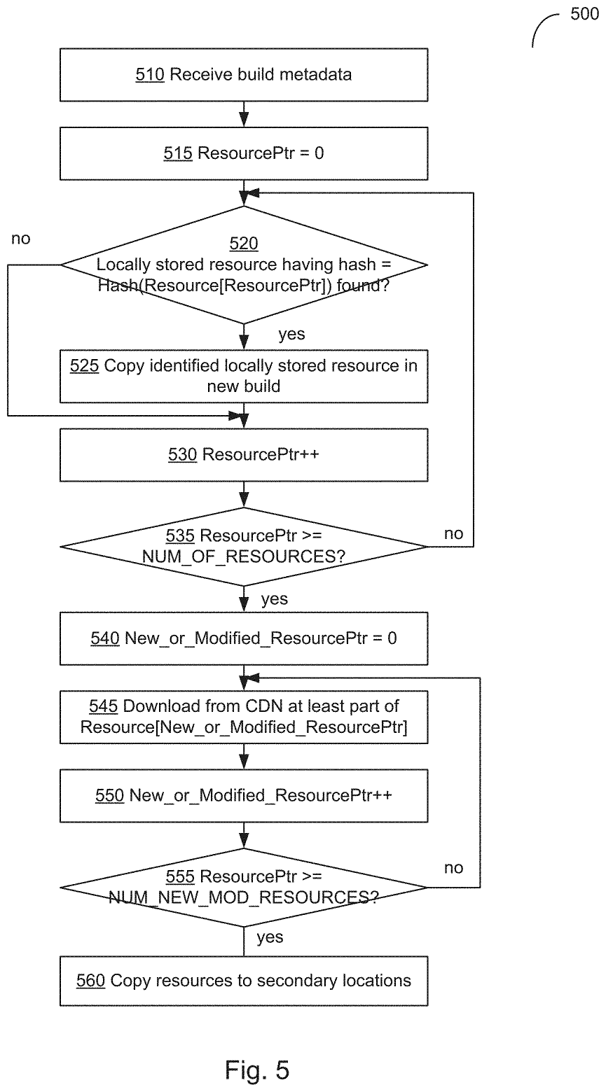

FIG. 5 depicts a flowchart of an example method 500 of efficient binary resource distribution to client computing devices, in accordance with one or more aspects of the present disclosure. Method 500 and/or each of its individual functions, routines, subroutines, or operations may be performed by one or more processors of a computing system performing the method (e.g., the client computing device 130 of FIG. 1). In certain implementations, the method 500 may be performed by a client computing device in accordance with a patch plan created by the example method 300, as described in more detail herein above.

In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other. Therefore, while FIG. 5 and the associated description lists the operations of method 500 in certain order, various implementations of the method may perform at least some of the described operations in parallel and/or in arbitrary selected orders.

At block 510, the client computing device implementing the method may receive build metadata associated with a new build of a software product. For each resource, the build metadata may specify the file in which the resource is stored, the resource offset within the file, the resource size, and the resource hash. The current build metadata (e.g., the metadata associated with the locally stored current build) is presumed to be available and locally stored by the client computing device, e.g., since it was previously downloaded at the time of initial installation or the previous upgrade of the software product, as described in more detail herein above.

At blocks 515-535, the client computing device may identify, based on the current build metadata and the new build metadata, a subset of reusable locally stored binary resources comprised by a current build of the software product, such that each binary resource of the subset matches a corresponding binary resource of the new build.

In particular, at block 515, the client computing device may initialize the resource pointer to be utilized for iterating over the resources of the new build.

Responsive to identifying, at block 520, a matching current build resource having a hash that matches the hash of the new build resource identified by the pointer, the identified current build resource may, at block 525, be reused in the new build. In an illustrative example, the identified current build resource may be copied from the current build file and the offset within the current build file specified by the current build metadata to the new build file and the offset within the new build file specified by new build metadata, as described in more details herein above.

At block 530, the resource pointer may be incremented.

Responsive to determining, at block 535 that the list of resources of the new build has not yet been exhausted, the method may loop back to block 520; otherwise, the processing may continue at block 540.

At block 540, the client computing device may initialize the resource pointer to be utilized for iterating over the new or modified resources of the new build (i.e., resources of the new build for which corresponding resources of the current build do not exist or cannot be reused without at least some modifications).

At block 545, the client computing device may download from the CDN at least part of the resource identified by the pointer. In certain implementations, the resources may be fully downloaded from the CDN. Alternatively, block scanning may be performed in order to identify any locally stored blocks which can be reused for the resource in the new build, as described in more detail herein above. The downloaded or modified resource may be locally saved to the new build file and the offset within the new build file specified by new build metadata, as described in more details herein above.

At block 550, the resource pointer may be incremented.

Responsive to determining, at block 555 that the list of resources of the new build has not yet been exhausted, the method may loop back to block 545; otherwise, the processing may continue at block 560.

At block 560, the client computing device may the locally copy at least some of the updated and/or newly downloaded resources in order to create any requisite duplicate instances of the resources in the new build, as described in more detail herein above.

Responsive to completing the operations of block 560, the method may terminate.

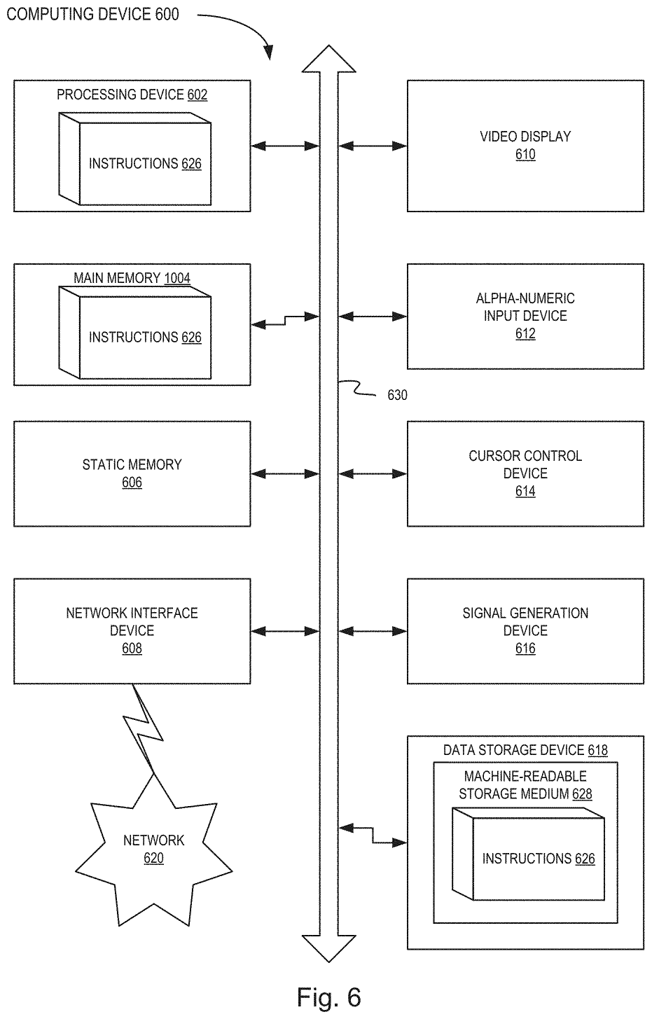

FIG. 6 schematically illustrates a diagrammatic representation of a computing device 600 which may implement the systems and methods described herein. In various illustrative examples, computing device may implement various components of FIGS. 1-3, including database servers, storage nodes, application servers, etc.

Computing device 600 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute module 626 implementing methods 300 and/or 500 of efficient binary resource distribution to client computing devices, in accordance with one or more aspects of the present disclosure, for performing the operations and steps discussed herein.

Computing device 600 may further include a network interface device 606 which may communicate with a network 620. The computing device 600 also may include a video display unit 66 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 66, alphanumeric input device 612, and cursor control device 614 may be combined into a single component or device (e.g., an LCD touch screen).

Data storage device 618 may include a computer-readable storage medium 628 on which may be stored one or more sets of instructions, e.g., instructions of module 626 implementing methods 300 and/or 500 of efficient binary resource distribution to client computing devices. Instructions implementing module 626 may also reside, completely or at least partially, within main memory 604 and/or within processing device 602 during execution thereof by computing device 600, main memory 604 and processing device 602 also constituting computer-readable media. The instructions may further be transmitted or received over a network 620 via network interface device 606.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

1. A method, comprising:
receiving, by a client computing device, build metadata associated with a new build of a software product, wherein the new build comprises a plurality of binary resources;
identifying, based on the build metadata, a subset of reusable locally stored binary resources comprised by a current build of the software product, wherein each binary resource of the subset matches a corresponding binary resource of the new build;
responsive to identifying a binary resource of the new build, such that the binary resource that does not have a corresponding reusable locally stored binary resource of the current build, identifying least a part of the binary resource to be downloaded from a content delivery network (CDN); and
creating a patch plan for upgrading the current build of the software product to a new build level associated with the new build, wherein the patch plan specifies at least one of: a directory structure to be created on the client computing device, a plurality of files to be created within the directory structure on the client computing device, or a plurality of secondary locations of duplicate instances of binary resources on the client computing devices.

2. The method of claim 1, further comprising:
saving, in view of the build metadata, the binary resource at a first location on the client computing device; and
copying, in view of the build metadata, the binary resource to a second location on the client computing device.

3. The method of claim 1, wherein identifying the subset of reusable locally stored binary resources further comprises:
for each binary resource of the new build, comparing a hash of the resource with a plurality of hashes of locally stored binary resources.

4. The method of claim 1, wherein identifying the part of the binary resource to be downloaded from the CDN further comprises:
identifying a subset of a plurality of blocks comprised by the binary resource, such that each block comprised by the subset does not have a corresponding locally stored block; and
downloading the subset of the plurality of blocks from the CDN.

5. The method of claim 4, wherein identifying the subset of the plurality of blocks further comprises:
for each block of the plurality of blocks comprised by the binary resource, comparing a hash of the block with a plurality of hashes of locally stored blocks.

6. The method of claim 1, wherein the binary resource is represented by one of: a data file, a graphic asset, a multimedia asset, or a sound stream.

7. The method of claim 1, wherein the software product is represented by an interactive videogame.

8. The method of claim 1, wherein the patch plain further specifies at least one of:
a plurality of locally stored reusable binary resources or a plurality of binary resources to be downloaded from the CDN.

9. The method of claim 1, wherein the build metadata specifies, for each binary resource, a hash value of the binary resource, an offset of the binary resource in a file, and a size of the binary resource.

10. A computing device, comprising:
a memory; and
a processor, communicatively coupled to the memory, the processor configured to:
receive build metadata associated with a new build of a software product, wherein the new build comprises a plurality of binary resources;
identify, based on the build metadata, a subset of reusable locally stored binary resources comprised by a current build of the software product, wherein each binary resource of the subset matches a corresponding binary resource of the new build;
responsive to identifying a binary resource of the new build, such that the binary resource that does not have a corresponding reusable locally stored binary resource of the current build, download at least a part of the binary resource from a content delivery network (CDN)); and
create a patch plan for upgrading the current build of the software product to a new build level associated with the new build, wherein the patch plan specifies at least one of: a directory structure to be created on the client computing device, a plurality of files to be created within the directory structure on the client computing device, or a plurality of secondary locations of duplicate instances of binary resources on the client computing devices.

11. The computing device of claim 10, wherein the processor is further configured to:
save, in view of the build metadata, the binary resource at a first location on the client computing device; and
copy, in view of the build metadata, the binary resource to a second location on the client computing device.

12. The computing device of claim 10, wherein identifying the subset of reusable locally stored binary resources further comprises:
for each binary resource of the new build, comparing a hash of the resource with a plurality of hashes of locally stored binary resources.

13. The computing device of claim 10, wherein downloading at least a part of the binary resource from the CDN further comprises:
identifying a subset of a plurality of blocks comprised by the binary resource, such that each block comprised by the subset does not have a corresponding locally stored block; and
downloading the subset of the plurality of blocks from the CDN.

14. The computing device of claim 10, wherein the binary resource is represented by one of: a data file, a graphic asset, a multimedia asset, or a sound stream.

15. The computing device of claim 10, wherein the patch plain further specifies at least one of:
a plurality of locally stored reusable binary resources or a plurality of binary resources to be downloaded from the CDN.

16. A computer-readable non-transitory storage medium comprising executable instructions that, when executed by a computing device, cause the computing device to:
receive build metadata associated with a new build of a software product, wherein the new build comprises a plurality of binary resources;
identify, based on the build metadata, a subset of reusable locally stored binary resources comprised by a current build of the software product, wherein each binary resource of the subset matches a corresponding binary resource of the new build;
responsive to identifying a binary resource of the new build, such that the binary resource that does not have a corresponding reusable locally stored binary resource of the current build, identify least a part of the binary resource to be downloaded from a content delivery network (CDN)); and
create a patch plan for upgrading the current build of the software product to a new build level associated with the new build, wherein the patch plan specifies at least one of: a directory structure to be created on the client computing device, a plurality of files to be created within the directory structure on the client computing device, or a plurality of secondary locations of duplicate instances of binary resources on the client computing devices.

17. The computer-readable non-transitory storage medium of claim 16, further comprising executable instructions to cause the computing device to:
save, in view of the build metadata, the binary resource at a first location on the client computing device; and
copy, in view of the build metadata, the binary resource to a second location on the client computing device.

18. The computer-readable non-transitory storage medium of claim 16, wherein identifying the subset of reusable locally stored binary resources further comprises:
for each binary resource of the new build, comparing a hash of the resource with a plurality of hashes of locally stored binary resources.

19. The computer-readable non-transitory storage medium of claim 16, wherein identifying the part of the binary resource to be downloaded from the CDN further comprises:
identifying a subset of a plurality of blocks comprised by the binary resource, such that each block comprised by the subset does not have a corresponding locally stored block; and
downloading the subset of the plurality of blocks from the CDN.

20. The computer-readable non-transitory storage medium of claim 19, wherein identifying the subset of the plurality of blocks further comprises:
for each block of the plurality of blocks comprised by the binary resource, comparing a hash of the block with a plurality of hashes of locally stored blocks.
